(19) United States
(12) Patent Application Publication
(10) Pub. No.: US 2012/0033906 A1
(43) Pub. Date: Feb. 9, 2012

(54) Quick Replacement Bearing Axle for Tire Transfer Ring

(75) Inventor: Brian Painter, Walsall (GB)

(73) Assignee: Davian Enterprises, LLC, Greenback, TN (US)

(21) Appl. No.: 13/197,475

(22) Filed: Aug. 3, 2011

Related U.S. Application Data
(60) Provisional application No. 61/370,202, filed on Aug. 3, 2010.

(51) Int. Cl. F16C 33/02; F16C 17/02

(52) U.S. Cl. 384/416

(57) ABSTRACT

A bearing axle adapted to rotatably secure a mounting ring between opposing interior surfaces of respective spaced apart first and second housing rings of a tire transfer ring and to allow removal of the bearing axle from between the housing rings absent additional separation of the housing rings is disclosed. The bearing axle comprises an elongated shaft sized and shaped to extend between and terminate along the housing ring interior surfaces and at least one releasable fastener for securing the shaft between the housing ring interior surfaces. A roller bearing is mounted on the shaft and is adapted to engage the mounting ring to allow the mounting ring to rotate in relation to the housing rings. Release of the fastener allows the shaft to slide from between the housing ring interior surfaces absent additional separation of the housing rings.

### CROSS-REFERENCE TO RELATED APPLICATIONS

This application claims the benefit of U.S. Provisional Patent Application No. 61/370,202, filed on Aug. 3, 2010.

### STATEMENT REGARDING FEDERALLY SPONSORED RESEARCH OR DEVELOPMENT

Not Applicable

### BACKGROUND OF THE INVENTION

1. Field of Invention

This invention pertains to devices that are particularly useful in the manufacture of vehicle tires. More particularly, this invention pertains to a quickly replaceable bearing axle for a transfer ring used to grasp the outer circumference of a circular, tubular or round object which is useful, for example, in the manufacture of tires.

2.Description of the Related Art

Commonly, the process of manufacturing a tire, such as a motor vehicle tire, includes fabrication of a tire carcass as a precursor to the tire. This carcass typically includes an inner toroidal portion of the tire and typically excludes the outer circumferential reinforcing belt and tread package of the finished tire. Upon fabrication of the tire carcass at a first location, the carcass is typically transferred to a tire forming drum where the carcass is positioned for receiving a ring-shaped belt and tread package about the outer circumference of the carcass. The belt and tread package is fabricated separately from the carcass and therefore must be transferred from its manufacturing location to the location of the carcass positioned thereupon precisely about the circumference of the carcass. The geometry of the belt and tread package and the fact that it must be placed about the outer circumference of the carcass only permits the package to be grasped about its outer circumference for effecting the transfer.

In light of the above, transfer of the tire carcass and the belt and tread package is typically accomplished through use of one or more transfer rings defining an expandable and collapsible inner circumference suitable to serve as a circular surface to grasp the outer circumference of the tire carcass and/or belt and tread package. U.S. Pat. No. 5,441,587 (“the '587 patent), U.S. Pat. No. 5,709,768 (“the '768 patent”), and U.S. Patent Publication No. 2010/0000658 (“the '658 publication”), each of which is incorporated herein by reference, disclose transfer rings of this type. The device of the '587 patent includes generally first and second outer housing rings which are held in spaced apart and concentric relationship by a plurality of spaced apart bearing axles. A mounting ring is disposed between the housing rings and is rotatably mounted with respect to the housing rings by means of a plurality of roller bearings which are mounted on individual ones of the bearing axles. A plurality of shoes defining segments of an interiorly-facing circular working surface are disposed in a circular arrangement within the outer housing rings and are mounted by means of a plurality of first linkages to hinged pin connectors extending between the housing rings. The shoes are further mounted to the bearing axles by means of a plurality of second linkages. A drive mechanism is configured to rotate the mounting ring with respect to the housing rings, thereby rotating the first and second linkages of each shoe about central axes of respective hinged pin connectors or bearing axles for simultaneous radial movement of the plurality of shoes with respect to the outer housing rings.

Repeated use of a prior art transfer ring of the type discussed above often results in wear of one or more components of the bearing axles of the transfer rings, thus necessitating occasional replacement of one or more of these components, or of the entire bearing axle. However, the bearing axles of prior art transfer ring designs include first and second ends which are mounted within appropriate depressions in the outer housing rings of the transfer ring and extend therebetween to define a rigid, spaced apart relationship between the outer housing rings. Thus, in order to gain access to one of the bearing axles for repair or replacement of the bearing axle components, it has been necessary to remove at least one of the outer housing rings of the transfer ring. This process is both cumbersome and time consuming. Accordingly, a bearing axle for use in a transfer ring which can be quickly removed from the transfer ring and replaced absent removal of one or more of the outer housing rings of the transfer ring is desired.

### BRIEF SUMMARY OF THE INVENTION

According to one embodiment of the present general inventive concept, a quick replacement bearing axle which is adapted to rotatably secure a mounting ring between opposing interior surfaces of respective spaced apart first and second housing rings of a tire transfer ring is provided. The quick replacement bearing axle allows for removal from between the housing rings absent additional separation of the housing rings. In one embodiment, the present general inventive concept comprises an elongated shaft sized and shaped to extend between and terminate along the housing ring interior surfaces. In several embodiments, the shaft is sized and shaped to extend perpendicularly between the housing ring interior surfaces. In one embodiment of the present general inventive concept, the shaft defines a central portion. In certain embodiments, the first and second end surfaces each define a greater dimensional width than a cross-section of the shaft central portion.

At least one releasable fastener is provided for securing the shaft between the housing ring interior surfaces. The present general inventive concept may also include a roller bearing mounted on the shaft, the roller bearing being adapted to engage the mounting ring to allow the mounting ring to rotate in relation to the housing rings. In this embodiment, release of the releasable fastener allows the shaft to slide from between the housing ring interior surfaces absent additional separation of the housing rings.

In one embodiment of the present general inventive concept, the shaft defines a first end surface and an opposite second end surface. Each of the first and second end surfaces define a recess for receiving said at least one releasable fastener. This recess may comprise a cylindrical first blind bore opening outwardly to a respective end surface and extending along an axial dimension of the shaft, together with an internally threaded second blind bore extending along the axial dimension of the shaft and opening outwardly to an interior surface of the first blind bore. In certain embodiments, the at least one fastener is defined by a pair of shoulder bolts, each shoulder bolt being adapted to be received through one of a first through bore defined by the first housing ring and a second through bore defined by the second housing ring and received within one of the first and second end surface recesses to register the corresponding recess with the corresponding through bore, and thereby to join the end surface against the interior surface of the respective housing ring.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is an elevation view of a transfer ring incorporating several of one embodiment of a quick replacement bearing axle constructed in accordance with several features of the present invention;

FIG. 2 is a partial elevation view showing a close-up of the transfer ring of FIG. 1, including several quick replacement bearing axles of FIG. 1;

FIG. 3 is a cross-sectional view of the transfer ring of FIG. 2 showing a cross-sectional view of one quick replacement bearing axle of FIG. 2; and

FIG. 4 is a perspective view of one embodiment of a quick replacement bearing axle constructed in accordance with several features of the present invention.

### DETAILED DESCRIPTION OF THE INVENTION

A quick replacement bearing axle 10 is disclosed herein and in the various figures. The quick replacement bearing axle 10 of the present invention provides an improvement in a prior art transfer ring 12 which is useful, for example, in the manufacture of vehicle tires.

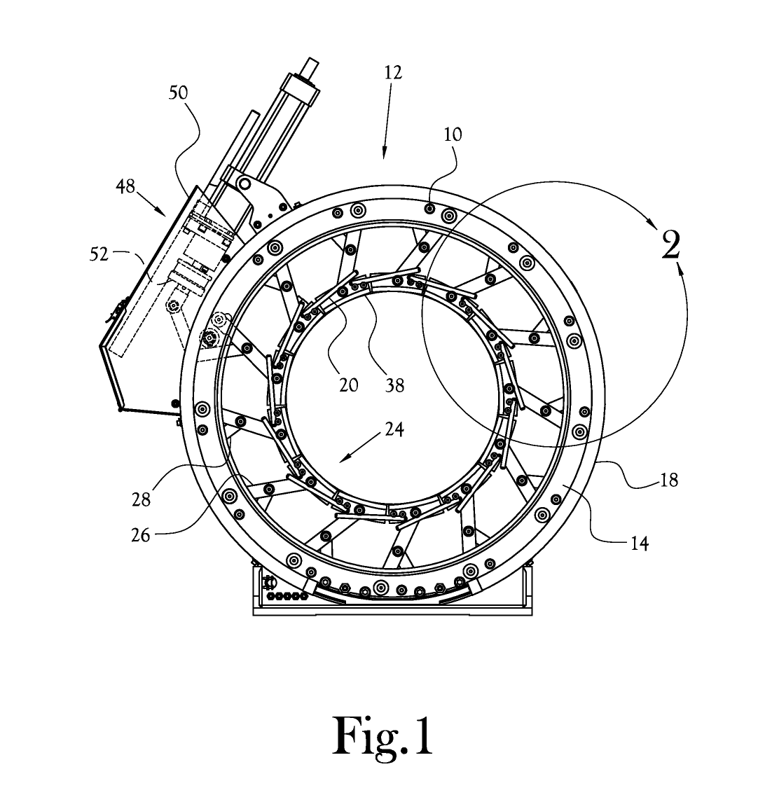

With initial reference to FIG. 1, a transfer ring 12 is depicted. The transfer ring 12 is of the ring-actuated type wherein the transfer ring 12 includes first and second outer housing rings 14, 16, respectively, held in a parallel, spaced apart and concentric relationship, with a mounting ring 18 rotatably mounted therebetween. The mounting ring 18 and housing rings 14, 16 of the depicted transfer ring 12 are mechanically connected by appropriate linkages 26, 28 to a plurality of shoes 20 disposed in a generally circular arrangement inward of the housing rings 14, 16 and the mounting ring 18. Each shoe 20 has an interior surface 38 which defines a segment of an interiorly-facing circular working surface 24. As discussed above, each shoe 20 is mounted for radial movement inwardly and outwardly of the transfer ring 12 upon rotation of the mounting ring 18 in relation to the housing rings 14, 16.

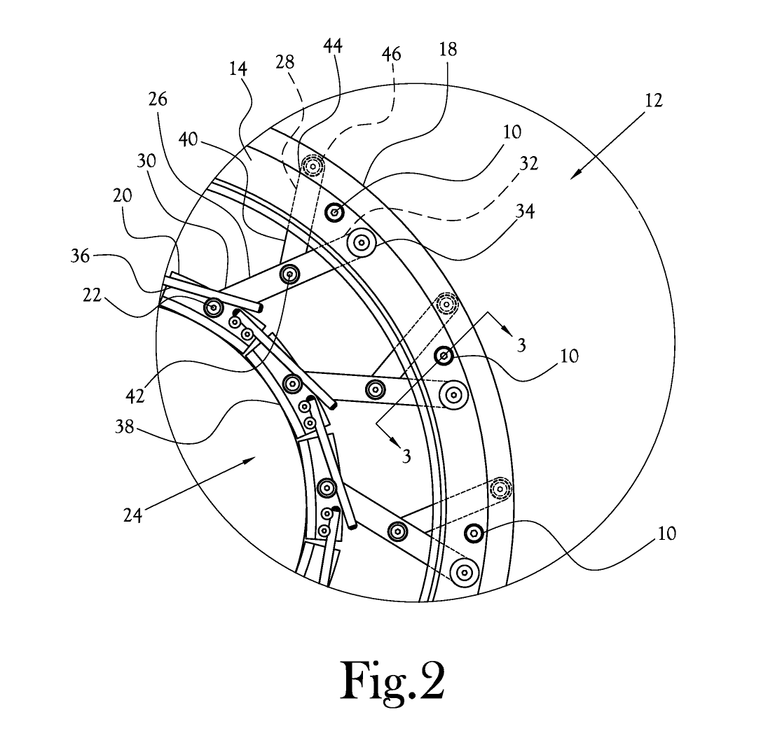

Referring to FIG. 2, in the depicted transfer ring 12, each shoe 20 is rotatably mounted to a first linkage 26 at a first end 30 thereof by a first hinged pin connector 22. A second end 32 of each first linkage 26 is rotatably mounted to a second hinged pin connector 34 extending between the housing rings 14, 16. A second linkage 28 is rotatably mounted at a first end 40 thereof to the first linkage 26 at a point along the length of the first linkage 26 by a third hinged pin connector 42. A second end 44 of the second linkage 28 is rotatably mounted to the mounting ring 18 by a fourth hinged pin connector 46. Each of the first, second, third, and fourth hinged pin connectors 22, 34, 42, 46 extend substantially parallel to an axial dimension of the mounting ring 18 and the housing rings 14, 16. Thus, rotation of the mounting ring 18 in relation to the housing rings 14, 16 causes movement of each fourth hinged pin connector 46 in relation to an associated second hinged pin connector 34 along the circumference of the transfer ring 12, thus causing the associated first and second linkages 26, 28 to rotate proximate one another about the third hinged pin connector 42 and the associated first linkage 26 to rotate about the second hinged pin connector 34 to swing the corresponding shoe 20 along an arcuate path radially inwardly toward or outwardly from a central axis of the housing rings 14, 16. The interior surfaces 38 of the various shoes 20 are held in a generally circular configuration during such radial inward and outward repositioning by a plurality of rigid rods 36 slidably secured along adjacent shoes 20. In this way, the diameter of the working surface 24 is expanded and contracted through rotation of the mounting ring 18 in relation to the housing rings 14, 16. Actuation of the mounting ring 18 commonly is effected by means of a piston/cylinder device 48 that is powered from a source of pressurized fluid and having a main housing 50 which is mounted to the housing rings 14, 16 and a piston 52 which is rotatably mounted in operable engagement with the mounting ring 18 such that selective extension and retraction of the piston 52 with respect to the housing 50 selectively rotates the mounting ring 18 in relation to the housing rings 14, 16. U.S. Pat. No. 5,441,587 provides further structural and operational information relating to this type of transfer ring 12 and is incorporated herein in its entirety by reference.

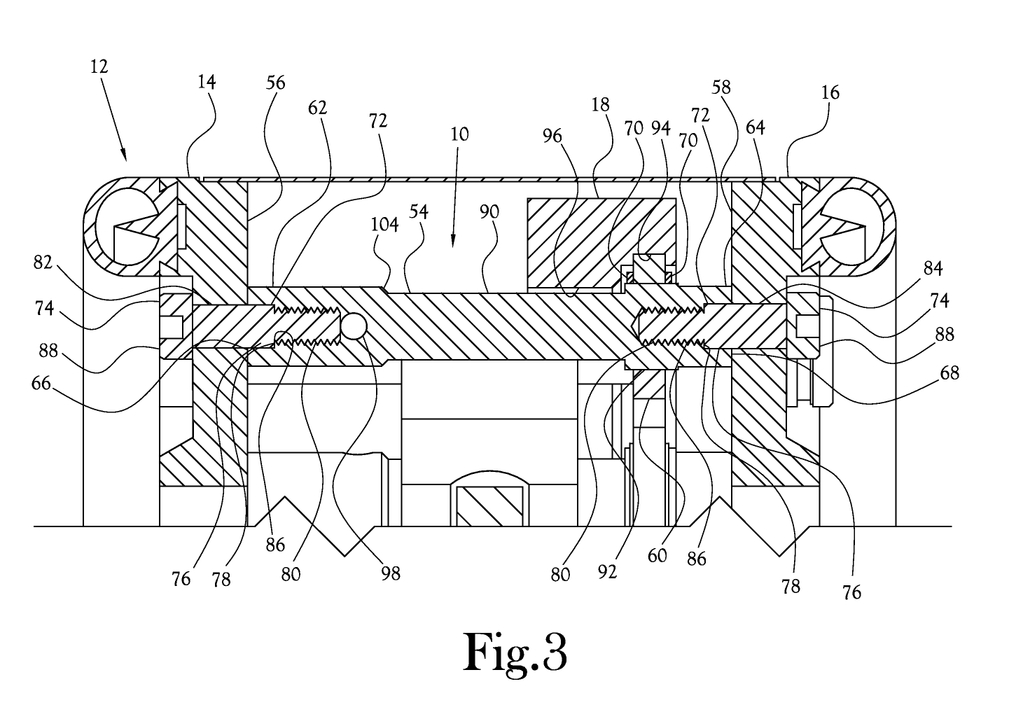

With reference to FIGS. 2 and 3, in one embodiment of the present invention, the mounting ring 18 is rotatably secured between the housing rings 14, 16 by a plurality of quick replacement bearing axles 10 of the present invention. In accordance with one aspect of the present invention, the quick replacement bearing axles 10 are interposed between opposing smooth interior surfaces 56, 58 of the housing rings 14, 16 and are spaced about the circumference of the transfer ring 12 such that the quick replacement bearing axles 10 cooperate to maintain the parallel, spaced apart, and concentric relationship of the housing rings 14, 16 with one another and with the mounting ring 18. Each quick replacement bearing axle, or bearing axle 10, generally comprises an elongated shaft 54 adapted to extend between the inside surfaces 56, 58 of the housing rings 14, 16, and a roller bearing 60 mounted along the shaft 54.

FIGS. 2-4 illustrate one embodiment of a bearing axle 10 of the present invention. Referring to FIGS. 2-4, the shaft 54 of the depicted bearing axle 10 is defined by an elongated member adapted to extend substantially perpendicularly between opposite first and second housing rings 14, 16 of a transfer ring 12. In the depicted transfer ring 12, the first housing ring 14 defines a first through bore 82 extending perpendicularly to an axial dimension of the transfer ring 12 and aligned in coaxial registration with a second through bore 84 defined by the second housing ring 16. The shaft 54 defines opposite first and second ends 62, 64 which are adapted to be removably secured between the interior surfaces 56, 58 of the housing rings 14, 16 in axial registration between the first and second through bores 82, 84.

In the illustrated embodiment, a first end 62 of the shaft 54 defines a first smooth end surface 66 adapted to abut the smooth interior surface 56 of the first housing ring 14 of the transfer ring 12 and to overlie the first through bore 82. Likewise, an opposite second end 64 of the shaft 54 defines a second smooth end surface 66 adapted to abut the smooth interior surface 58 of the second housing ring 16 of the transfer ring 12 and to overlie the second through bore. In the illustrated embodiment, each of the first and second end surfaces 66, 68 of the shaft 54 defines a recess 72 which is adapted to receive therein a fastener 74 to secure each respective end 62, 64 of the shaft 54 to its corresponding housing ring interior surface 56, 58 in axial registration with the first and second through bores 82, 84 defined by the housing rings 14, 16. For example, in the illustrated embodiment, each of the first and second end surfaces 66, 68 of the shaft 54 defines an outwardly opening first cylindrical blind bore 76 extending along an axial dimension of the shaft 54, with a second, internally-threaded cylindrical blind bore 80 defined inwardly of and coaxial to the first cylindrical blind bore 76. Each second blind bore 80 is of a narrower internal diameter than the corresponding first blind bore 76 and opens outwardly to an inward surface 78 of the first blind bore 76, such that the blind bores 76, 80 cooperate to define a circumferential lip 86 along the recess 72. In this embodiment, a pair of shoulder bolts 88 are provided to accomplish the fasteners 74, with each shoulder bolt 88 being sized to mate with one of the first and second through bores 82, 84 and with a corresponding recess 72 of a corresponding shaft end 62, 64 to secure the shaft 54 in coaxial registration with the first and second through bores 82, 84 of the housing rings 14, 16.

It will be recognized by one of skill in the art that the depicted first and second blind bores 76, 80 and mating shoulder bolts 88 are described for illustration purposes, and that the recesses 72 and corresponding fasteners 74 may take the shape and configuration of any of several embodiments of fasteners known in the art without departing from the spirit and scope of the present invention. As noted hereinabove, however, the bearing axles of prior art transfer rings are embedded within appropriate depressions in the inside surfaces of the housing rings of the transfer rings, and are thus incapable of being removed from between the housing rings absent separation of the housing rings from one another. Thus, it will be recognized that, in accordance with one feature of the present invention, disengagement of the fasteners 74 from the recesses 72 of the shaft 54 in the illustrated embodiment allows the shaft 54 to slide along the housing ring interior surface 56, 58 to facilitate removal of the bearing axle 10 from between the housing rings 14, 16 absent removal of either of the housing rings 14, 16 from the transfer ring 12 or other such separation of the housing rings 14, 16 from one another.

In several embodiments, the first and second ends 62, 64 of the shaft 54 have a greater girth in comparison to a central portion 90 of the shaft 54, such that the first and second end surfaces 66, 68 of the shaft 54 are of a greater dimensional width than a cross-section of the shaft central portion 90 perpendicular to the axial dimension of the shaft 54. In these embodiments, the first and second end surfaces 66, 68 each bear against the housing rings 14, 16 along a greater area of the housing ring interior surfaces 56, 58, thereby providing additional stability of the shaft 54 between the two housing rings 14, 16. For example, in the illustrated embodiment, the shaft central portion 90 and the first and second ends 62, 64 of the shaft 54 each define a cylindrical shape, with the first and second ends 62, 64 of the shaft 54 each having a greater cross-sectional diameter than the shaft central portion 90 and with an outwardly beveled portion 104 defined between the shaft central portion 90 and the shaft first end 62. However, those of skill in the art will recognize other shapes and configurations suitable for establishing the expanded first and second ends 62, 64 of the shaft 54, and such shapes and configurations may be used without departing from the spirit and scope of the present invention.

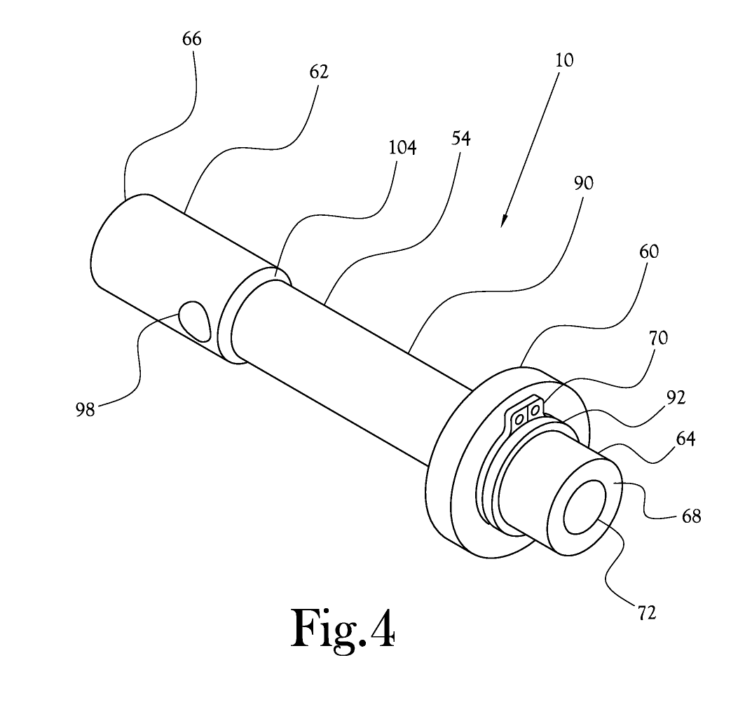

Referring to FIGS. 3 and 4, the central portion 90 of the shaft 54 defines a cylindrical region 92 which is adapted to receive the roller bearing 60 thereon. The roller bearing 60 is sized to surround and closely conform to the cylindrical region 92 and to be received within an appropriate groove 94 defined along an internal surface 96 of the mounting ring 18 to facilitate and guide rotation of the mounting ring 18 in relation to the housing rings 14, 16. It will thus be understood that the positioning of the cylindrical region 92 and the roller bearing 60 along the shaft 54 is governed by the desired rotational path of the mounting ring 18 and the spatial relationship between the mounting ring 18 and the housing rings 14, 16. For example, in the depicted transfer ring 12, the cylindrical region 92 is disposed adjacent the second end 64 of the shaft 54, with the roller bearing 60 disposed generally centrally along an axial dimension of the cylindrical region 92 to align with the mounting ring groove 94.

In several embodiments, the positioning and alignment of the roller bearing 60 along the cylindrical region 92 is adjustable. For example, in the illustrated embodiment, a pair of adjustable ring clamps 70 are provided adjacent opposite side surfaces 100, 102 of the roller bearing 60 to secure the roller bearing 60 along the cylindrical region 92. A through bore 98 is defined by the shaft 54 near the shaft first end 62 and extends substantially perpendicular to the axial dimension of the shaft 54. The shaft through bore 98 is sized and configured to receive therein a tool (not shown) of the type known in the art for repositioning the ring clamps 70 to adjust the alignment of the roller bearing 60 along the shaft 54 or for removal of the ring clamps 70 for repair or replacement of the roller bearings 60. In certain embodiments, the cylindrical region 92 of the shaft 54 is of an equal or greater thickness than the remainder of the shaft 54, thereby allowing more convenient removal of the roller bearing 60 from the shaft 54 for repair or replacement of the roller bearing 60.

From the foregoing description, it will be recognized by those skilled in the art that an improved quick replacement bearing axle 10 has been provided which allows for removal and replacement of the bearing axle 10 within a transfer ring 12 absent the need to remove either of the housing rings 14, 16 from the transfer ring 12 or to separate the housing rings 14, 16 from one another. However, while the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A bearing axle adapted to rotatably secure a mounting ring between opposing interior surfaces of respective spaced apart first and second housing rings of a tire transfer ring and to allow removal of said bearing axle from between the housing rings absent additional separation of the housing rings, said bearing axle comprising:
an elongated shaft sized and shaped to extend between and terminate along the housing ring interior surfaces;
at least one releasable fastener for securing said shaft between the housing ring interior surfaces; and
a roller bearing mounted on said shaft, said roller bearing being adapted to engage the mounting ring to allow the mounting ring to rotate in relation to the housing rings;
whereby release of said releasable fastener allows said shaft to slide from between the housing ring interior surfaces absent additional separation of the housing rings.

2. The bearing axle of claim 1, said shaft defining a first end surface and opposite second end surface, each of said first and second end surfaces defining a recess for receiving said at least one releasable fastener.

3. The bearing axle of claim 2, each said recess comprising:
a cylindrical first blind bore opening outwardly to said respective end surface and extending along an axial dimension of said shaft; and
an internally threaded second blind bore extending along said axial dimension of said shaft and opening outwardly to an interior surface of said first blind bore.

4. The bearing axle of claim 3, said at least one fastener being defined by a pair of shoulder bolts, each said shoulder bolt being adapted to be received through one of a first through bore defined by the first housing ring and a second through bore defined by the second housing ring and received within one of said first and second end surface recesses to register said corresponding recess with said corresponding through bore and to join said end surface against said interior surface of said respective housing ring.

5. The bearing axle of claim 2, said shaft defining a central portion, said first and second end surfaces each defining a greater dimensional width than a cross-section of said shaft central portion.

6. The bearing axle of claim 1, said shaft being sized and shaped to extend perpendicularly between the housing ring interior surfaces.

7. An improvement in a transfer ring useful in the manufacture of a vehicle tire or component thereof wherein the transfer ring includes spaced apart first and second housing rings and a mounting ring rotatably mounted therebetween, wherein each housing ring defines a smooth interior surface facing an opposite smooth interior surface of the other housing ring, and wherein a first housing ring defines a first through bore extending coaxially to a second through bore defined by the second housing ring, the improvement comprising:
an elongated shaft sized and shaped to register with the through bores and extend between the housing ring interior surfaces;
at least one releasable fastener for securing said shaft in said registration with the through bores between the housing ring interior surfaces; and
a roller bearing mounted on said shaft, said roller bearing being adapted to engage the mounting ring to allow the mounting ring to rotate in relation to the housing rings;
whereby release of said releasable fastener allows said shaft to slide from between the housing ring interior surfaces absent additional separation of the housing rings.

8. The bearing axle of claim 7, said shaft defining a first end surface and opposite second end surface, each of said first and second end surfaces being adapted to overly one of said through bores, each said first and second end surfaces defining a recess for receiving said at least one releasable fastener.

9. The bearing axle of claim 8, each said recess comprising:
a cylindrical first blind bore opening outwardly to said respective end surface and extending along an axial dimension of said shaft; and
an internally threaded second blind bore extending along said axial dimension of said shaft and opening outwardly to an interior surface of said first blind bore.

10. The bearing axle of claim 9, said at least one fastener being defined by a pair of shoulder bolts, each said shoulder bolt being adapted to be received within and mate with one of said through bores and a corresponding recess to register said corresponding recess with said corresponding through bore and to join said shaft between said housing rings in registration between said through bores.

11. The bearing axle of claim 8, said shaft defining a central portion, said first and second end surfaces each defining a greater dimensional width than a cross-section of said shaft central portion.
